(19) United States
(12) Patent Application Publication
(10) Pub. No.: US 2014/0344205 A1
(43) Pub. Date: Nov. 20, 2014

(54) SMART MEDIA DEVICE ECOSYSTEM USING LOCAL AND REMOTE DATA SOURCES

(71) Applicants: Michael Edward Smith Luna, San Jose, CA (US); Thomas Alan Donaldson, London (GB); Hawk Pang, San Jose, CA (US)

(72) Inventors: Michael Edward Smith Luna, San Jose, CA (US); Thomas Alan Donaldson, London (GB); Hawk Pang, San Jose, CA (US)

(73) Assignee: AliphCom, San Francisco, CA (US)

(21) Appl. No.: 13/894,850

(22) Filed: May 15, 2013

(51) Int. Cl. G06N 5/02

(52) U.S. Cl. CPC G06N 5/025
USPC 706/47

(57) ABSTRACT

Techniques associated with a smart media ecosystem using local and remote data sources are described, including creating accounts using a smart media device, receiving predetermined media data from separate device, associating the predetermined media data with at least one of the accounts, receiving sensor data from a sensor array, processing the predetermined media data and the sensor data using a learning algorithm configured to generate media preferences, and storing media preferences in an account profile associated with at least one of the accounts. In some embodiments, a method also includes storing sensor data in association with an account, correlating the sensor data with stored data, which includes local data and remote data, selecting media content using the sensor data and the stored data, and sending a control signal to a media player, the control signal configured to cause the media player to play the media content.

### FIELD

The present invention relates generally to electrical and electronic hardware, computer software, wired and wireless network communications, and computing devices. More specifically, techniques related to smart media device ecosystem using local and remote data sources are described.

### BACKGROUND

Conventional devices and techniques for providing media content are limited in a number of ways. Conventional media devices (i.e., media players, such as speakers, televisions, computers, e-readers, smartphones) typically are not well-suited for selecting targeted media content for a particular user. While some conventional media devices are capable of operating applications or websites that provide targeted media content services, such services typically provide media content only on a device capable of downloading or running that media service application or website. Such applications or websites typically are unable to select or control other media devices in a user's ecosystem of media devices for providing media content.

Conventional media services and devices also typically do not automatically select media content in view of environmental or physiological factors associated with a user. Nor are they typically configured to identify and cross-reference local data with remote data, for example, from one or more third party media services. Conventional media devices also typically are not configured to target media content for a user based on media preferences specified by a user across multiple media services.

Thus, what is needed is a solution for a smart media device ecosystem using local and remote data sources without the limitations of conventional techniques.

### BRIEF DESCRIPTION OF THE DRAWINGS

Various embodiments or examples (“examples”) are disclosed in the following detailed description and the accompanying drawings:

FIG. 1 illustrates an exemplary smart media device ecosystem including local and remote data sources;

FIG. 2 illustrates an exemplary smart media device ecosystem including multiple media devices;

FIG. 3 illustrates a diagram of exemplary elements in a smart media device ecosystem;

FIG. 4 illustrates a diagram of exemplary types of account profiles generated and stored in a smart media device;

FIG. 5A illustrates an exemplary flow for creating an account profile in a smart media device ecosystem;

FIG. 5B illustrates an exemplary flow for selecting and providing media content using local and remote data sources; and

FIG. 6 illustrates an exemplary system and platform for implementing a smart media device ecosystem using local and remote data sources.

Although the above-described drawings depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof. If implemented as software, then the described techniques may be implemented using various types of programming, development, scripting, or formatting languages, frameworks, syntax, applications, protocols, objects, or techniques, including ASP, ASP.net, .Net framework, Ruby, Ruby on Rails, C, Objective C, C++, C#, Adobe® Integrated Runtime™ (Adobe® AIR™), ActionScript™, Flex™, Lingo™, Java™, Javascript™, Ajax, Perl, COBOL, Fortran, ADA, XML, MXML, HTML, DHTML, XHTML, HTTP, XMPP, PHP, and others. Software and/or firmware implementations may be embodied in a non-transitory computer readable medium configured for execution by a general purpose computing system or the like. The described techniques may be varied and are not limited to the examples or descriptions provided.

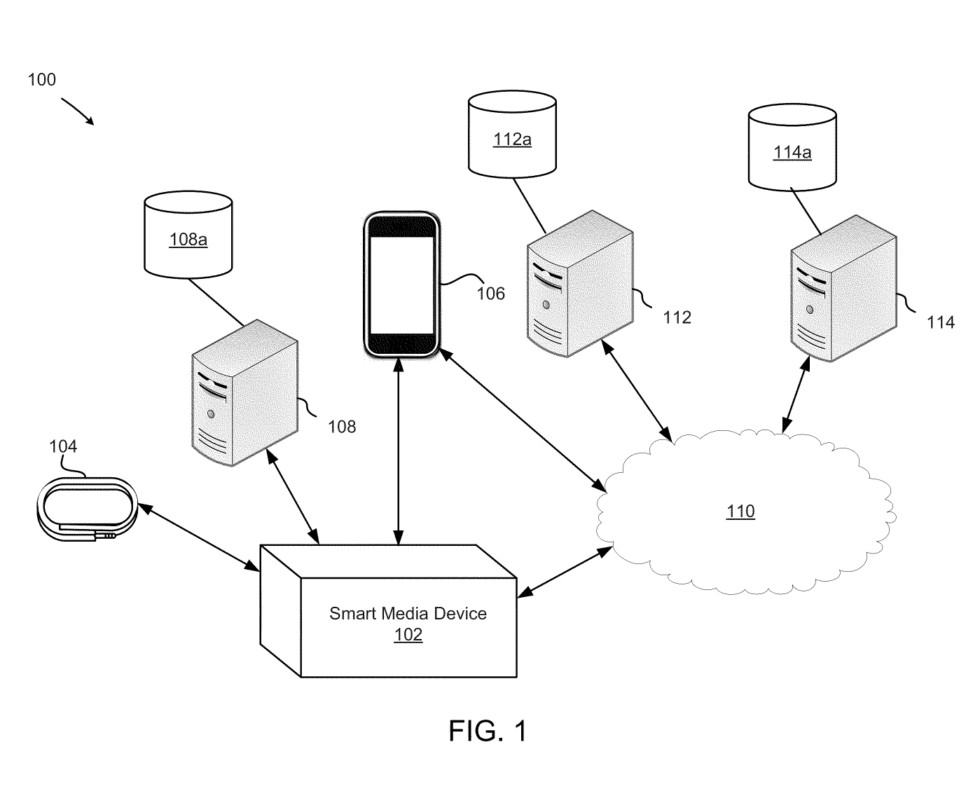

FIG. 1 illustrates an exemplary smart media device ecosystem including local and remote data sources. Here, system 100 includes smart media device 102, wearable device 104, mobile device 106, network 110, server 108 implemented with database 108a, server 112 implemented with database 112a, and server 114 implemented with database 114a. In some examples, smart media device 102 may be configured to communicate with other devices (e.g., wearable device 104, mobile device 106, server 108, network 110, servers 112-114, and the like) using short range communication protocols (e.g., Bluetooth®, ultra wideband, NFC, and the like) and long range communication protocols (e.g., satellite, mobile broadband, global positioning system (GPS), IEEE 802.11a/b/g/n (WiFi), and the like). For example, smart media device 102 may be configured to exchange data (e.g., media content data, media configuration data, media preference data, media service data, social network data, account data, and the like) with wearable device 104, mobile device 106 and server 108 using Bluetooth®. In another example, smart media device 102 may be configured to access data from servers 112-114 using a WiFi connection through network 110. In some examples, smart media device 102 may be configured to generate and store data associated with individual users (i.e., in accounts or account profiles, as described herein). In some examples, where an individual user is associated with wearable device 104 and/or mobile device 106, smart media device 102 may obtain information and data associated with said individual user from wearable device 104 and/or mobile device 106, including media preference data (i.e., associated with a user's preferences for consuming media content (e.g., preferred types, genres, specific content, sources of content, locations or environments for consuming content, and the like), including music, videos, movies, articles, books,

Internet content, other audio and visual content, and the like), user identification data, device identification data, data associated with an established media service account (e.g., Pandora®, Spotify®, Rdio®, Last.fm®, Hulu®, Netflix®, and the like), data associated with an established social network account (e.g., Facebook®, Twitter®, LinkedIn®, Yelp®, Google+®, Instagram®, and the like), or other media or account data. In some examples, smart media device 102 may obtain media and account-related data from local sources (e.g., wearable device 104, mobile device 106, server 108 and the like). In other examples, smart media device 102 may obtain such data from remote sources (e.g., servers 112-114 using network 110, mobile device 106 using network 110, or the like). For example, in addition to the user-specific data described above, smart media device 102 also may be configured to obtain social, demographic, or other third-party proprietary or public media data from remote sources, including servers 112-114 (i.e., implementing databases 112a-114a), which may be associated with (i.e., owned, operated, or used by) a media service (e.g., Pandora®, Spotify®, Rdio®, Last.fm®, Hulu®, Netflix®, and the like), a social networking service (e.g., Facebook®, Twitter®, LinkedIn®, Yelp®, Google+®, Instagram®, and the like), or other third party entity. For example, a media service may store remote data in one or both of databases 112a-114a associated with media categories (e.g., music, movie, other video, article, book (i.e., ebook), webpage, news, advertisement, or the like), demographic preferences (e.g., popular, most viewed, most played, trending, or other preference associated with a demographic), geographic preferences (e.g., popular, most viewed, most played, trending, or other preference associated with a geography), account-specific preferences (e.g., most liked, most viewed, most played, trending, or other preferences associated with an established media service account), or the like, without limitation. In some examples, databases 112a-114a may be implemented using servers 112-114, and may be managed by a database management system (“DBMS”). Databases 112a-114a also may be accessed (i.e., for searching, collecting and/or downloading stored data), by wearable device 104 or mobile device 106, using network 122 (e.g., cloud, Internet, LAN, or the like). In other examples, the quantity, type, function, structure, and configuration of the elements shown may be varied and are not limited to the examples provided.

In some examples, smart media device 102 may be configured to generate and store user-specific media preferences, for example, in an account profile, which may be associated with a user or group of users (i.e., “user group”). In some examples, a user group may include a family, a household, an office, a team, a group of specified individuals, or the like. In some examples, said media preferences may encompass local data associated with, for example, a user's or user group's environment, locally stored media content, direct media preference inputs, media preferences provided by other local sources, and the like. In other examples, said media preferences also may encompass remote data associated with a user's or user group's media service accounts and social network accounts, including previously selected media content, genres, types, and other preferences.

In some examples, wearable device 104 may be configured to be worn or carried. In some examples, wearable device 104 may be implemented as a data-capable strapband, as described in co-pending U.S. patent application Ser. No. 13/158,372, co-pending U.S. patent application Ser. No. 13/180,320, co-pending U.S. patent application Ser. No. 13/492,857, and co-pending U.S. patent application Ser. No. 13/181,495, all of which are herein incorporated by reference in their entirety for all purposes. In some examples, wearable device 104 may include one or more sensors (i.e., a sensor array) configured to collect local sensor data. Said sensor array may include, without limitation, an accelerometer, an altimeter/barometer, a light/infrared (“IR”) sensor, a pulse/heart rate (“HR”) monitor, an audio sensor (e.g., microphone, transducer, or others), a pedometer, a velocimeter, a global positioning system (GPS) receiver, a location-based service sensor (e.g., sensor for determining location within a cellular or micro-cellular network, which may or may not use GPS or other satellite constellations for fixing a position), a motion detection sensor, an environmental sensor, a chemical sensor, an electrical sensor, or mechanical sensor, and the like, installed, integrated, or otherwise implemented on wearable device 104. In other examples, wearable device 104 also may capture data from distributed sources (e.g., by communicating with mobile computing devices, mobile communications devices, computers, laptops, distributed sensors, GPS satellites, or the like) for processing with sensor data. In still other examples, the quantity, type, function, structure, and configuration of the elements shown may be varied and are not limited to the examples provided.

In some examples, mobile device 106 may be implemented as a smartphone, a tablet, laptop, or other mobile communication or mobile computing device. In some examples, mobile device 106 may include, without limitation, a touchscreen, a display, one or more buttons, or other user interface capabilities. In some examples, mobile device 106 also may be implemented with various audio and visual/video output capabilities (e.g., speakers, video display, graphic display, and the like). In some examples, mobile device 106 may be configured to operate various types of applications associated with media, social networking, phone calls, video conferencing, calendars, games, data communications, and the like. For example, mobile device 106 may be implemented as a media device configured to store, access and play media content.

In some examples, wearable device 104 and/or mobile device 106 may be configured to provide sensor data, including environmental and physiological data, to smart media device 102. In some examples, wearable device 104 and/or mobile device 106 also may be configured to provide derived data generated by processing the sensor data using one or more algorithms to determine, for example, advanced environmental data (e.g., whether a location is favored or frequented, whether a location is indoor or outdoor, home or office, public or private, whether other people are present, whether other compatible devices are present, weather, location-related services (e.g., stores, landmarks, restaurants, and the like), air quality, news, and the like) from said environmental data, and activity, mood, behavior, medical condition and the like from physiological data. In some examples, smart media device 102 may be configured to cross-correlate said sensor data and said derived data with other local data, as well as remote data (e.g., social, demographic, or other third-party proprietary or public media data from remote sources) to select media content for smart media device 102, or other media player, to play or provide. In some examples, smart media device 102 may select media content from a local source, a remote source, or both. In other examples, the quantity, type, function, structure, and configuration of the elements shown may be varied and are not limited to the examples provided.

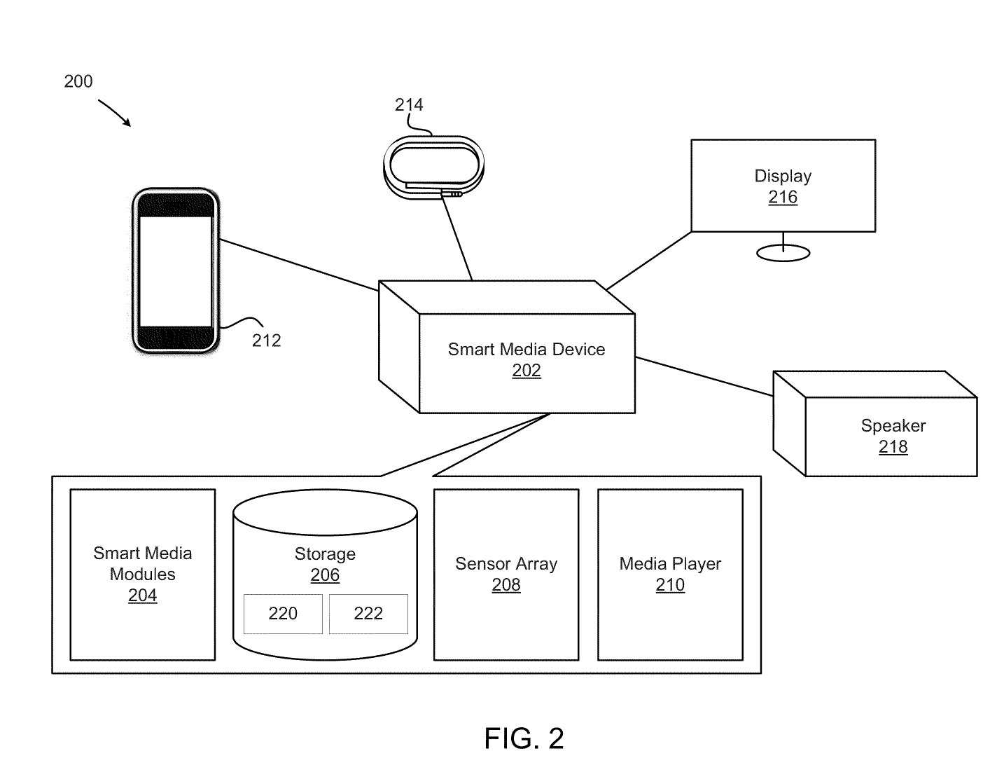

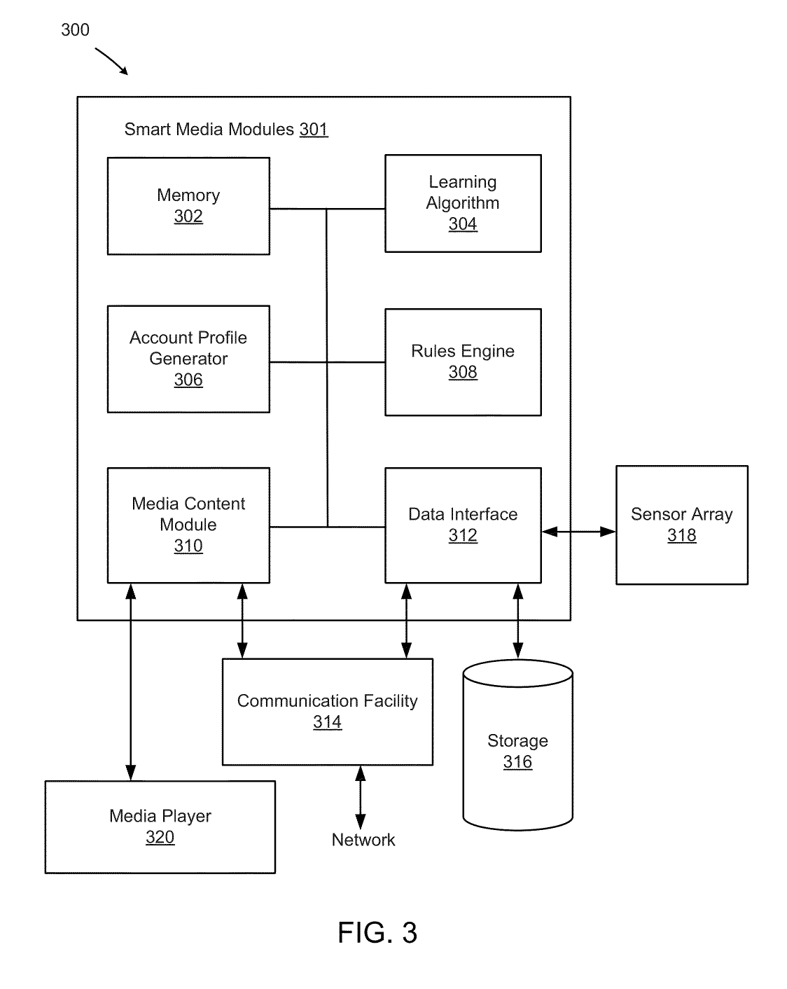

FIG. 2 illustrates an exemplary smart media device ecosystem including multiple media devices. Here, system 200 includes smart media device 202 (including smart media modules 204, storage 206, sensor array 208 and media player 210), mobile device 212, wearable device 214, display 216 and speaker 218. Like-numbered and named elements may describe the same or substantially similar elements as those shown in other descriptions. In some examples, smart media device 202 may be configured to automatically select media content (i.e., to be played using media player 210, display 216, speaker 218 and/or mobile device 212) for a user or user group using smart media modules 204. In some examples, smart media modules 204 may include a learning algorithm (e.g., learning algorithm 304 in FIG. 3 and the like) configured to learn media tastes and preferences of a user or user group. In some examples, smart media modules 204 also may include a rules engine (e.g., rules engine 308 in FIG. 3, and the like) configured to prioritize, combine, and mix the media tastes and preferences of two or more users (i.e., in a user group) to assist in selecting media content, as well as prioritize devices for playing or providing media content. In some examples, smart media modules 204 also may include a media content module (e.g., media content module 310 in FIG. 3, and the like) configured to select media content using data from various sources, including account profiles, other stored data, sensor data, remote data, said learning algorithm, said rules engine, and the like. In some examples, smart media modules 204 also may include an account profile generator (e.g., account profile generator 306 in FIG. 3, and the like) configured to create, structure and update (i.e., modify with new or current data) profiles associated with one or more user or user group accounts, including associating media preferences, account information, and other data, with an account profile.

In some examples, smart media device 202 also may include storage 206, which may be configured to store various types of data, including profile data 220 and content data 222. In some examples, profile data 220 may include data associated with a user's or user group's stored account information, media preferences, historical data (i.e., prior user activity, account or media-related), and the like. In some examples, historical data may include local sensor data previously collected (e.g., by sensor array 208, wearable device 214, mobile device 212, or the like) and associated with a user account (i.e., stored in an account profile). For example, historical data may include environmental data previously captured using sensor array 208 and associated with a media preference and a user account. In another example, historical data may include activity, physiological, behavioral, environmental and other information determined using local sensor data previously collected by wearable device 214 being worn by a user identified with an account by smart media device 202. In some examples, historical data may include metrics correlating various types of pre-calculated sensor data. Such metrics may provide insights into a user's media preferences in relation to certain environments (e.g., location, time, setting, weather, and the like), and such insights may be used by smart media modules 204 to automatically select media content for a present user in a present environment. In some examples, content data 222 may include data associated with stored media content previously downloaded (e.g., from local sources such as mobile device 212, display 216 or speaker 218, or from remote sources, such as remote databases (e.g., databases 112a-114a in FIG. 1, and the like)), which may have been manually selected by a user or automatically selected using smart media modules 204. In other examples, the quantity, type, function, structure, and configuration of the elements shown may be varied and are not limited to the examples provided.

In some examples, smart media device 202 also may include sensor array 208 configured to provide sensor data, including data associated with an environment in which smart media device 202 is located. In some examples, smart media modules 204 may be configured to use such sensor data to customize a selection of media content for said environment. For example, sensor data provided by sensor array 208 may indicate noise levels, heat levels, light levels, and a number of compatible devices congruent with a lively, public atmosphere, and thus may select automatically an up tempo playlist associated with a present user or user group, or other media content matching such an environment. In some examples, smart media modules 204 may be configured to process said sensor data to derive more advanced environmental data (e.g., public or private/alone setting, home or office setting, indoor or outdoor setting, and the like) or behavioral data (i.e., through a user's interactions with smart media device 202). In some examples, smart media device 202 may be configured to use sensor array 208 or a separate communications facility (e.g., including an antenna, short range communications controller, or the like) to detect a presence, proximity, and/or location of compatible devices (i.e., devices with communication and operational capabilities in common with smart media device 202) (e.g., mobile device 212, wearable device 214, display 216, speaker 218, or the like).

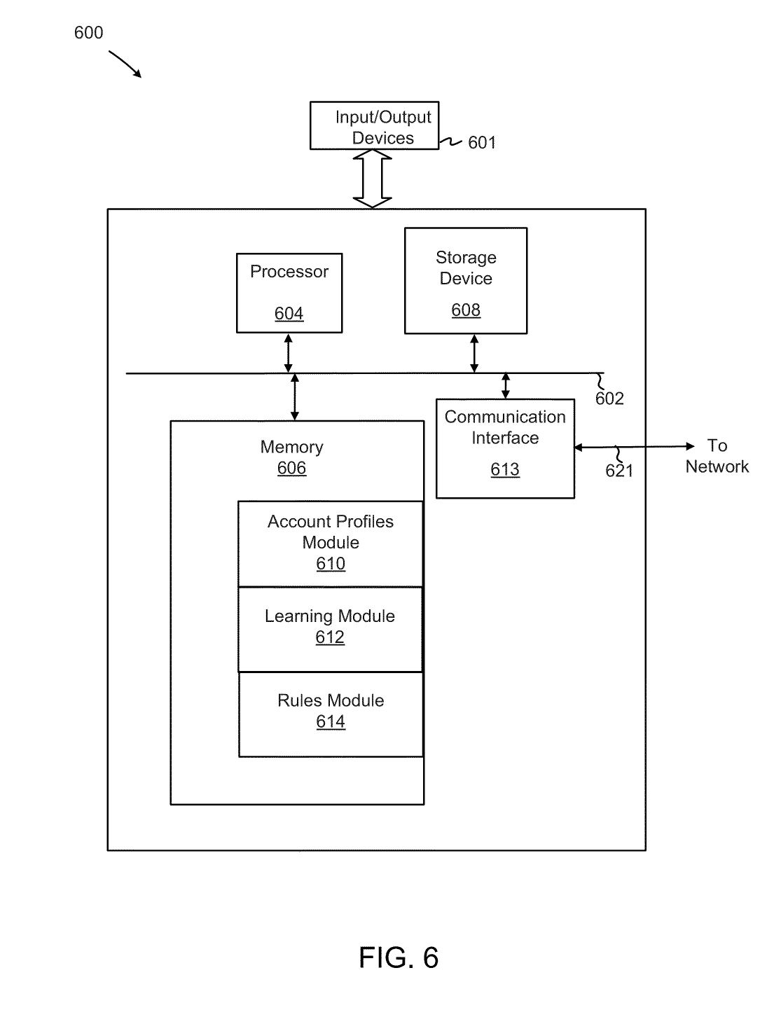

In some examples, smart media device 202 also may include logic (not shown) implemented as firmware or application software that is installed in a memory (e.g., memory 302 in FIG. 3, memory 606 in FIG. 6, or the like) and executed by a processor (e.g., processor 604 in FIG. 7, or the like). Such logic may include program instructions or code (e.g., source, object, binary executables, or others) that, when initiated, called, or instantiated, perform various functions. In some examples, logic may provide control functions and signals to other components of smart media device 202. In other examples, the quantity, type, function, structure, and configuration of the elements shown may be varied and are not limited to the examples provided.

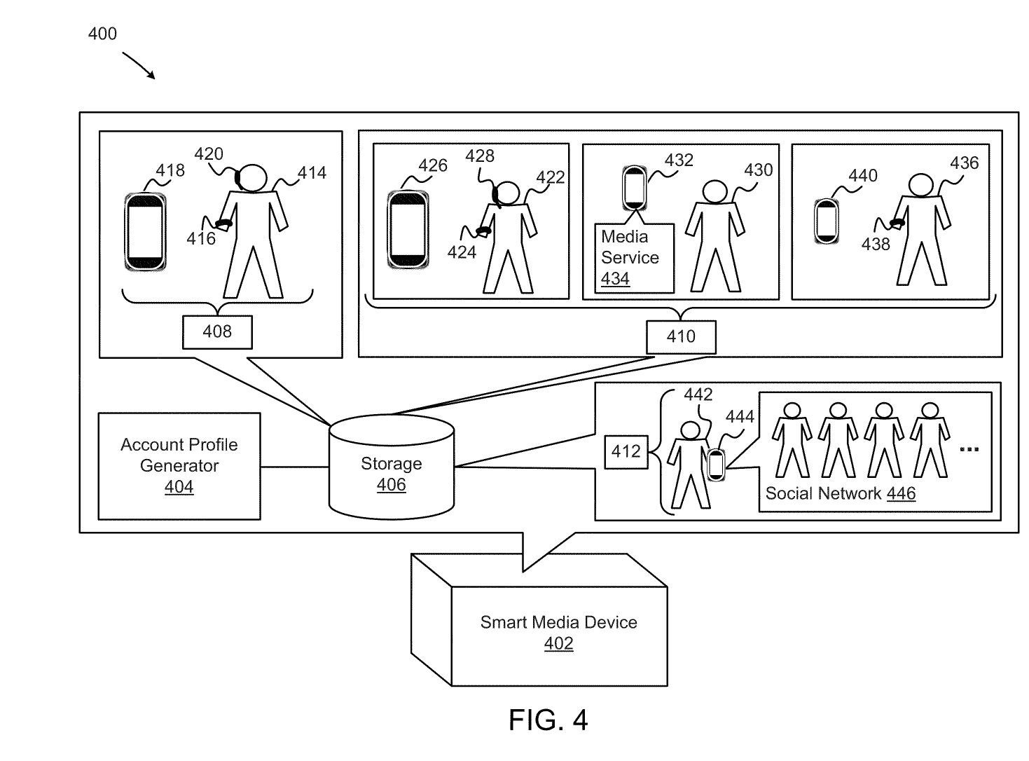

FIG. 3 illustrates a diagram of exemplary elements in a smart media device ecosystem. Here, diagram 300 includes smart media modules 301, memory 302, learning algorithm 304, account profile generator 306, rules engine 308, media content module 310, data interface 312, communication facility 314, storage 316, sensor array 318 and media player 320. Like-numbered and named elements may describe the same or substantially similar elements as those shown in other descriptions. In some examples, the elements shown in diagram 300 may be implemented in a single device (e.g., smart media device 102 in FIG. 1, smart media device 202 in FIG. 2, or the like). In other examples, one or more elements shown in diagram 300 may be implemented separately. For example, sensor array 318 may be implemented as part of a smart media device (e.g., sensor array 208 in FIG. 2, or the like), or in a wearable device (e.g., wearable device 104 in FIG. 1, wearable device 214 in FIG. 2, or the like), a mobile device (e.g., mobile device 106 in FIG. 1, mobile device 212 in FIG. 2, or the like), or may be distributed across multiple devices. In another example, storage 316 may be implemented as part of a smart media device (e.g., storage 206 in FIG. 2, storage 406 in FIG. 4, storage 608 in FIG. 6, or the like), or as a separate local storage device (e.g., server 108 and database 108a in FIG. 1, or the like). In still another example, media player 320 may be implemented as part of a smart media device (e.g., media player 210 in FIG. 2, or the like), or separately (e.g., mobile device 106 in FIG. 1, mobile device 212, display 216 and speaker 218 in FIG. 2, or the like). In other examples, the quantity, type, function, structure, and configuration of the elements shown may be varied and are not limited to the examples provided.

In some examples, learning algorithm 304 may be configured to learn media tastes and preferences of a user or user group (i.e., associated with an account created and maintained by account profile generator 306). In some examples, learning algorithm 304 may use environmental and behavioral data from sensor array 318, remote data (e.g., social, demographic, or other third-party proprietary or public media data from remote sources) obtained using communication facility 314, stored data (e.g., historical and other profile data from storage 316, and the like), and other local data (e.g., from other media devices associated with a user's or user group's account profile) to generate data pertaining to a user's or user group's media tastes and preferences, both general (e.g., genres, types, styles, media services, social networks, and the like) and specific (e.g., identified playlists, songs, movies, videos, articles, books, advertisements and other media content, as well as environments associated highly, positively, or otherwise, with said identified media content).

In some examples, account profile generator 306 may be configured to create accounts and account profiles to identify individual users or user groups and to associate the users and user groups with media preference data (e.g., learned tastes and preferences, favored or frequented environments, correlations between media content consumption and an environment, or the like). In some examples, an account may be associated with an individual user. In other examples, an account may be associated with a user group, including, without limitation, a family, a household, a household member's social network, or other social graphs. In some examples, account data (e.g., user identification data, device identification data, metadata, and the like) and media preference data may be stored in one or more profiles associated with an account (e.g., using storage 316 or the like).

In some examples, rules engine 308 may be configured to prioritize media preference data (i.e., indicating media tastes and preferences of a user) associated with an account profile, as well as to mix or combine media preference data associated with multiple users or user groups, in order to provide media content module 310 with data with which to select media content. In some examples, rules engine 308 may comprise a set of rules configured to prioritize both general and specific media preference data according to various conditions, including environment (e.g., time, location, and the like), available devices (i.e., for playing media content), presence of a user, and the like. In some examples, rules engine 308 also may be configured to prioritize among different available media devices, for providing media content to a user, considering type of media content, a user's preferences, available devices, and the like. In some examples, rules engine 308 also may be configured to prioritize accounts and account profiles according to whether an associated user or user group is a primary or frequent user (e.g., registered owner of a smart media device, is a sole member of a household, is a member of a family of registered owners and frequent user, or the like), or lesser priority (e.g., friend of an owner, unknown user, or the like).

In some examples, data interface 312 may be configured to receive and send data associated with functions provided by smart media modules 301, sensor array 318, storage 316, communication facility 314. For example, data interface 312 may be configured to receive remote data from communication facility 314 for use by account profile generator 306 to create or update a profile stored in storage 316, or for use by media content module 310 to select or customize media content to be played using media player 320. In another example, data interface 312 may be configured to receive sensor data from sensor array 318 for use by learning algorithm 304 to inform media tastes and preferences with environmental data, or for use by media content module 310 to select or customize media content. In other examples, the quantity, type, function, structure, and configuration of the elements shown may be varied and are not limited to the examples provided.

FIG. 4 illustrates a diagram of exemplary types of account profiles generated and stored in a smart media device. Here, diagram 400 includes smart media device 402, which includes account profile generator 404 and storage 406. In some examples storage 406 may be configured to store profiles 408-412. Like-numbered and named elements may describe the same or substantially similar elements as those shown in other descriptions. In some examples, account profile generator 404 may be configured to create, update, and otherwise modify profiles 408-412. In some examples, account profile generator 404 may receive or obtain data from various devices associated with an account. For example, profile 408 may be associated with an account identifying user 414, as well as wearable device 416, mobile device 418 and headset 420, which may be devices personal to, or used by, user 414. In some examples, wearable device 416, mobile device 418 and headset 420 may provide various types of data (e.g., media preference data, account data, identification data, content data, sensor data, and the like) to account profile generator 404 to create or update profile 408.

In some examples, a profile may be associated with more than one account. For example, profile 410 may be associated with multiple accounts identifying users 422, 430 and 436, and their respective associated devices. In this example, profile 410 may be associated with an account identifying user 422, as well as user 422′s associated devices, including wearable device 424, mobile device 426 and headset 428. Profile 410 also may include data identifying user 430 and associated devices, including mobile device 432. Profile 410 also may include data from media service 434, to which user 430 may have an account. In some examples, remote data from media service 434 may be accessed using mobile device 432. In other examples, mobile device 432 may be configured to operate an application associated with media service 434, and may locally store data associated with user 430's account with media service 434. Profile 410 also may include data identifying user 436 and associated devices, including wearable device 438 and mobile device 440. Profile 410 may be created and updated with data from one or more of said devices identified in accounts for users 422, 430 and 436. In other examples, profile 410 may be associated with a single account generated for a user group including users 422, 430 and 436, for example, if user 422, 430 and 436 were members of a household, a family, a work group, an office, or other group or social graph.

In some examples, a profile may be associated with a user's social network. For example, profile 412 may be associated with an account identifying user 442, as well as with social network 446 associated with user 442. In some examples, media preference data associated with social network 446, as may be indicated using a social networking service (e.g., Facebook®, Twitter®, LinkedIn®, Yelp®, Google+®, Instagram®, and the like), may be stored in profile 412 in association with user 442. In some examples, data associated with media preferences of social network 446 (e.g., media content is being consumed by members of social network 446, genres and types of media being consumed by members of social network 446, associated trends, media services being used by members of social network 446, and the like) may be obtained using mobile device 444 (e.g., implementing an application, accessing remote data using a network and long range communication protocol, as described herein, and the like). In other examples, the quantity, type, function, structure, and configuration of the elements shown may be varied and are not limited to the examples provided.

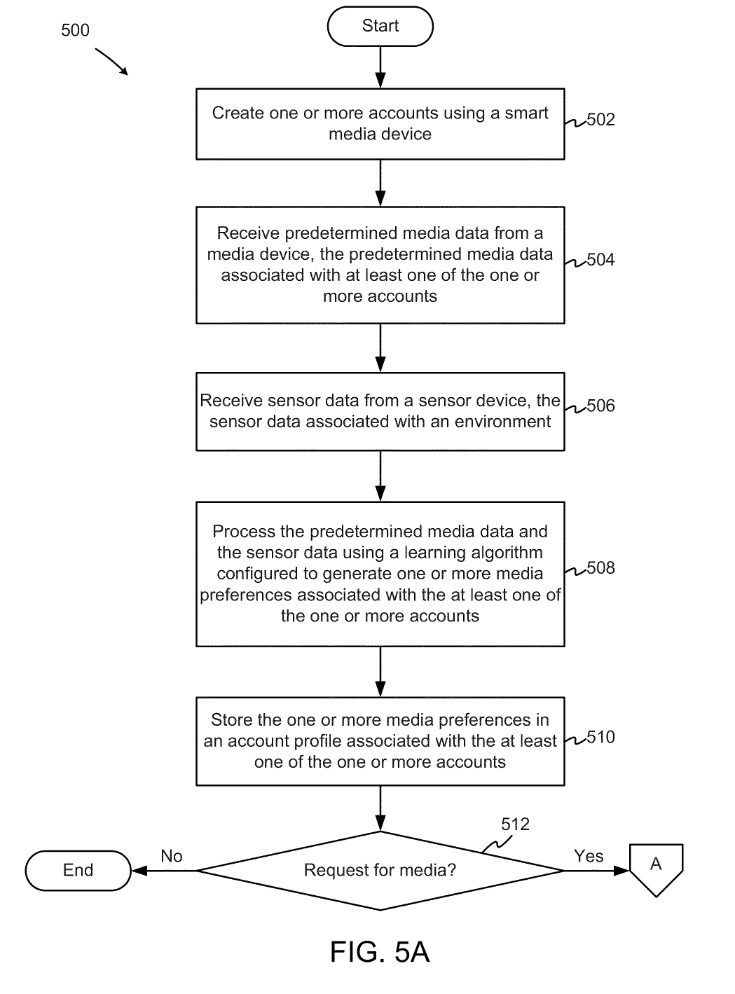

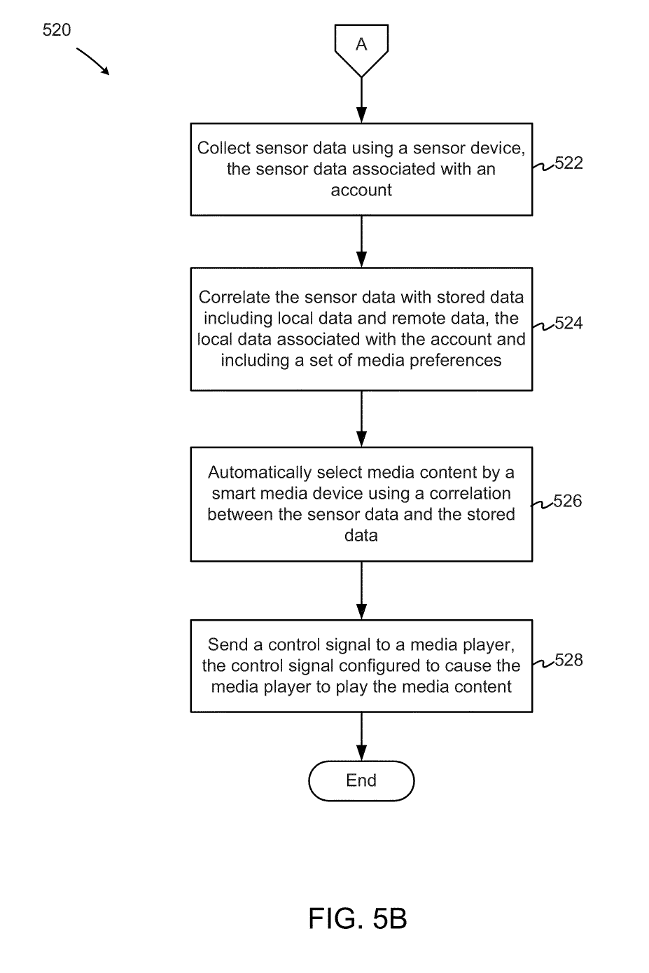

FIG. 5A illustrates an exemplary flow for creating an account profile in a smart media device ecosystem. Here, flow 500 begins with creating one or more accounts using a smart media device (502). Then predetermined media data from a media device may be received by the smart media device, the predetermined media data associated with at least one of the one or more accounts (504). In some examples, once an account is created, identifying data may be associated with the account, including identifying a user, as well as devices, established media service accounts and established social network accounts associated with said user. In some examples, predetermined media data may include media preference information previously specified in association with, for example, an established media service account (e.g., Pandora®, Spotify®, Rdio®, Last.fm®, Hulu®, Netflix®, and the like) or established social network account (e.g., Facebook®, Twitter®, LinkedIn®, Yelp®, Google+®, Instagram®, and the like). For example, a user may have indicated a preference for a song, a video, or a movie, using one or more accounts said user previously established with a media service or a social network, and data associated with said preference may be predetermined media data received from a media player and associated with at least one account. In some examples, sensor data from a sensor device also may be received by the smart media device, the sensor data associated with an environment (506). In some examples, the sensor device may be implemented with or in said smart media device, and may provide sensor data associated with an environment in which the smart media device is located. In other examples, the sensor device may be implemented separately (e.g., as a wearable device, a mobile device, or other media device, as described herein, or the like), and may provide sensor data associated with a different environment, for example, associated with a user or a user's activity. In some examples, the sensor data may include data associated with time, location, setting, time of day, light levels, noise levels, presence of other people, presence of other devices, and the like. In other examples, the sensor data also may be associated with a user's physiology, behavior, activity, mood, or the like. In some examples, a smart media device may process the predetermined media data and the sensor data using a learning algorithm configured to generate one or more media preferences associated with the at least one of the one or more accounts (508). Then the one or more media preferences may be stored in an account profile associated with the at least one of the one or more accounts (510). If there is a present request received by a smart media device for media (i.e., media content), for example, as provided by user input by a user interface, then said smart media device also may select and provide media content using local and remote data sources. In other examples, the above-described process may be varied in steps, order, function, processes, or other aspects, and is not limited to those shown and described.

FIG. 5B illustrates an exemplary flow for selecting and providing media content using local and remote data sources. Here, flow 520 begins with collecting sensor data using a sensor device, the sensor data associated with an account (522). In some examples, the sensor device may include a sensor array. In other examples, sensor data may be collected using a sensor array, which may be distributed across two or more devices. In some examples, collecting the sensor data may include data associated with an environment in which the sensor device is located. In other examples, the sensor data may include data associated with an activity, physiological condition, mood, medical condition, and the like. The sensor data may then be correlated (i.e., by a smart media device, as described herein) with stored data including local data and remote data, the local data associated with the account and including a set of media preferences (524). In some examples, local data may comprise historical data and may be stored in a smart media device. In other examples, local data may be stored or provided by other devices capable of exchanging data with a smart media device using short range communication protocols. In still other examples, remote data may be stored and provided by other devices, databases, or services capable of exchanging data with a smart media device using long range communication protocols. In some examples, remote data may comprise data from a media service, as described herein. In other examples, remote data may comprise data from a social network, as described herein. In some examples, a smart media device may be configured to correlate historical data from more than one remote source (e.g., more than one media service and/or social networking service) with sensor data. Once sensor data and stored data have been correlated, media content may be automatically selected by a smart media device using a correlation between the sensor data and the stored data (526). In some examples, the sensor data may identify a user and a present environment, and a smart media device (e.g., implementing one or more smart media modules, as described herein) may correlate the user with an account and a set of media preferences associated with said account. A smart media device also may correlate present environmental data with one or more media preferences associated with said account. For example, where said set of media preferences includes a playlist, an artist, a genre, or the like (e.g., provided using a remote data source, such as a media service to which a user has an established account, or using a local data source, such as a local storage) for winding down at the end of a workday, and said sensor data indicates a user to be alone in a room at the a time corresponding to an end of a workday, a smart media device may correlate such data and automatically select said playlist, artist or genre of music to play. In another example, where said set of media preferences includes an up tempo song recently and frequently played during an activity (e.g., running, dancing, working out, cycling, walking, swimming, or the like), and said sensor data indicates a user currently engaging in said activity, a smart media device may correlate such data and automatically select said song to play. In some examples, a smart media device may obtain data configured to play said playlist, artist, genre, or song, from a remote data source or a local data source. Then, a control signal may be sent by a smart media device to a media player, the control signal configured to cause the media player to play the media content (528), which has been selected automatically by the smart media device. In some examples, a set of media preferences may account for, or include, historical data sourced from two or more media services and/or social networking services, thereby cross-referencing preferences specified by a user across various media and social network accounts. In other examples, the above-described process may be varied in steps, order, function, processes, or other aspects, and is not limited to those shown and described.

FIG. 6 illustrates an exemplary system and platform for implementing a smart media device ecosystem using local and remote data sources. In some examples, computing platform 600 may be used to implement computer programs, applications, methods, processes, algorithms, or other software to perform the above-described techniques. Computing platform 600 includes a bus 602 or other communication mechanism for communicating information, which interconnects subsystems and devices, such as processor 604, system memory 606 (e.g., RAM, etc.), storage device 608 (e.g., ROM, etc.), a communication interface 613 (e.g., an Ethernet or wireless controller, a Bluetooth controller, etc.) to facilitate communications via a port on communication link 621 to communicate, for example, with a computing device, including mobile computing and/or communication devices with processors. Processor 604 can be implemented with one or more central processing units (“CPUs”), such as those manufactured by Intel® Corporation, or one or more virtual processors, as well as any combination of CPUs and virtual processors. Computing platform 600 exchanges data representing inputs and outputs via input-and-output devices 601, including, but not limited to, keyboards, mice, audio inputs (e.g., speech-to-text devices), user interfaces, LCD or LED or other displays (e.g., display 216 in FIG. 2, displays implemented on mobile device 106 in FIG. 1 or mobile device 212 in FIG. 2, or the like), monitors, cursors, touch-sensitive displays, speakers, media players and other I/O-related devices.

According to some examples, computing platform 600 performs specific operations by processor 604 executing one or more sequences of one or more instructions stored in system memory 606, and computing platform 600 can be implemented in a client-server arrangement, peer-to-peer arrangement, or as any mobile computing device, including smart phones and the like. Such instructions or data may be read into system memory 606 from another computer readable medium, such as storage device 608. In some examples, hard-wired circuitry may be used in place of or in combination with software instructions for implementation. Instructions may be embedded in software or firmware. The term “computer readable medium” refers to any non-transitory medium that participates in providing instructions to processor 604 for execution. Such a medium may take many forms, including but not limited to, non-volatile media and volatile media. Non-volatile media includes, for example, optical or magnetic disks and the like. Volatile media includes dynamic memory, such as system memory 606.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 602 for transmitting a computer data signal.

In some examples, execution of the sequences of instructions may be performed by computing platform 600. According to some examples, computing platform 600 can be coupled by communication link 621 (e.g., a wired network, such as LAN, PSTN, or any wireless network) to any other processor to perform the sequence of instructions in coordination with (or asynchronous to) one another. Computing platform 600 may transmit and receive messages, data, and instructions, including program code (e.g., application code) through communication link 621 and communication interface 613. Received program code may be executed by processor 604 as it is received, and/or stored in memory 606 or other non-volatile storage for later execution.

In the example shown, system memory 606 can include various modules that include executable instructions to implement functionalities described herein. In the example shown, system memory 606 includes account profiles module 610 configured to create and modify profiles, as described herein. System memory 606 also may include learning module 612, which may be configured to learn media tastes and preferences of one or more users, as described herein. System memory 606 also may include rules module 614, which may be configured to operate a rules engine, as described herein.

In some embodiments, various devices described herein may communicate (e.g., wired or wirelessly) with each other, or with other compatible devices, using computing platform 600. As depicted in FIGS. 1-4 herein, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIGS. 1-4 can represent one or more algorithms. Or, at least one of the elements can represent a portion of logic including a portion of hardware configured to provide constituent structures and/or functionalities.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, smart media devices 102, 202 and 402, including one or more components, can be implemented in one or more computing devices that include one or more circuits. Thus, at least one of the elements in FIGS. 1-4 can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

The foregoing description, for purposes of explanation, uses specific nomenclature to provide a thorough understanding of the invention. However, it will be apparent to one skilled in the art that specific details are not required in order to practice the invention. In fact, this description should not be read to limit any feature or aspect of the present invention to any embodiment; rather features and aspects of one embodiment can readily be interchanged with other embodiments. Notably, not every benefit described herein need be realized by each embodiment of the present invention; rather any specific embodiment can provide one or more of the advantages discussed above. In the claims, elements and/or operations do not imply any particular order of operation, unless explicitly stated in the claims. It is intended that the following claims and their equivalents define the scope of the invention. Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed is:

1. A method, comprising:
collecting sensor data using a sensor array;
associating the sensor data with an account;
correlating, using a rules engine, the sensor data with stored data comprising local data and remote data, the local data associated with the account and comprising a set of media preferences;
selecting media content using the sensor data and the stored data; and
sending a control signal to a media player, the control signal configured to cause the media player to play the media content.

2. The method of claim 1, further comprising updating the set of media preferences using media data input using a user interface.

3. The method of claim 1, further comprising updating the set of media preferences using media data received from a media device associated with the account.

4. The method of claim 1, wherein the local data comprises historical data.

5. The method of claim 1, wherein the remote data comprises data from a media service.

6. The method of claim 1, wherein the remote data comprises data from a social network.

7. The method of claim 1, wherein collecting the sensor data comprises capturing data associated with an environment in which the sensor array is located.

8. The method of claim 1, wherein collecting the sensor data comprises capturing data associated with an activity using a wearable device housing the sensor array.

9. The method of claim 1, wherein collecting the sensor data comprises capturing physiological data using a wearable device housing the sensor array.

10. The method of claim 9, wherein collecting the sensor data further comprises determining a mood using the physiological data.

11. A method, comprising:
creating a plurality of accounts using a smart media device;
receiving predetermined media data from another device;
associating the predetermined media data with at least one of the plurality of accounts;
receiving sensor data from a sensor array;
processing the predetermined media data and the sensor data using a learning algorithm configured to generate one or more media preferences; and
storing the one or more media preferences in an account profile associated with the at least one of the plurality of accounts.

12. The method of claim 11, further comprising receiving identifying information from the another device, the identifying information associated with the predetermined media data.

13. The method of claim 11, wherein creating the plurality of accounts comprises associating an account with a device in communication with the smart media device.

14. The method of claim 11, wherein creating the plurality of accounts comprises:
receiving account identification information using a user interface; and
storing the account identification information in association with an account profile.

15. The method of claim 11, wherein creating the plurality of accounts comprises:
receiving media preference information using a user interface; and
storing the media preference information in association with an account profile.

16. The method of claim 11, wherein creating the plurality of accounts comprises:
receiving media preference information from a device in communication with the smart media device; and
storing the media preference information in association with an account profile.

17. The method of claim 11, wherein creating the plurality of accounts comprises:
receiving data from a third party database, the data associated with an established social network account; and
storing the data in association with an account profile.

18. The method of claim 11, wherein creating the plurality of accounts comprises:
receiving data from a third party database, the data associated with an established media service account; and
storing the data in association with an account profile.

19. The method of claim 11, further comprising:
storing the sensor data in association with the at least one of the plurality of accounts;
correlating, using a rules engine, the sensor data with stored data comprising local data and remote data, the local data associated with the at least one of the plurality of accounts and comprising a set of media preferences;
selecting media content using the sensor data and the stored data; and
sending a control signal to a media player, the control signal configured to cause the media player to play the media content.
